(19) United States
(12) Patent Application Publication
(10) Pub. No.: US 2006/0288002 A1
(43) Pub. Date: Dec. 21, 2006

(54) Reordered search of media fingerprints

(75) Inventors: Michael A. Epstein, Spring Valley, NY (US); Raymond J. Krasinski, Suffern, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/555,836

(22) PCT Filed: Dec. 5, 2003
(86) PCT No.: PCT/IB04/05799

§ 371 Date: Nov. 7, 2005

Related U.S. Application Data
(60) Provisional application No. 60/434,574, filed on Dec. 19, 2002.
(60) Provisional application No. 60/467,436, filed on May 2, 2003.

(51) Int. Cl. G06F 17/30; G06F 7/00

(52) U.S. Cl. 707/6

(57) ABSTRACT

A method and system effects a search of a large database (190) based on a reordering (130) of the conventional byte-order of multi-byte identifiers that identify elements in a database. The reordering (130) is selected to provide a more uniform distribution of the identifiers in the database. The database is organized and/or sorted (140, 340) based on the reordered bytes forming the identifiers of the elements in the database. By effecting a reordered byte-order search (150, 350) of uniformly distributed identifiers, the likelihood of a mismatch being detected sooner can be expected to increase in most situations, thereby improving the speed of finding a match or exhaustively searching the database.

This invention relates to the field of consumer electronics, and in particular to a method and system that facilitates an efficient search of digital fingerprints.

U.S. patent application US 2002/0032864 A1, “CONTENT IDENTIFIERS TRIGGERING CORRESPONDING RESPONSES”, filed 14 May 2001 for Geoffrey B. Rhoads and Kenneth L. Levy, presents a variety of techniques that are commonly used to create one or more “fingerprints” based on the contents of a dataset, such as an audio or video file, and is incorporated by reference herein. The fingerprint of a dataset is commonly used to access ancillary information related to the dataset, such as an identification of the title of the dataset, the performing artist, the composer, the director, and so on. Additionally, the fingerprint of the dataset may be used to verify access rights to the dataset and/or to assess fees associated with such access. Other uses of an identifier of a dataset based on the contents of the dataset are common in the art.

Commonly used fingerprints associated with entertainment material, such as audio and video recording are intended to uniquely identify the recording, and as such, are of substantial length. For example, a 128-byte format for the signature of professional/commercial audio recordings is common. A database of hundreds of thousands of such signatures can be expected to be used for uniquely identifying commercial audio recordings, and efficient searching techniques for large identifiers in large databases are required.

Further complicating the task of fingerprint searching, there may not be a one-to-one correspondence between a fingerprint and a dataset. A fingerprint may be based on the entire contents of the dataset, or based on one or more select segments of the dataset. Because the fingerprint is based on the contents of the dataset, the sampling of the dataset to obtain a fingerprint may produce different fingerprints for the same dataset. A search of a database of fingerprints to find a match with a currently determined fingerprint often requires multiple searches through the database, based on alternative samples of the dataset, and/or a search through a database that contains multiple fingerprints for the same dataset.

Consider, for example, a database of songs, and a signature creation scheme that provides an average of ten different fingerprints for the same song. The database can be constructed to contain the ten most frequently occurring fingerprints for each song, or it could be constructed to contain the single most likely fingerprint. When an as-yet-unknown dataset is sampled to produce a “search” signature, it may or may not match a signature in the database, either because this particular song is not included in the database, or because the song is in the database but the particular search signature is not one of the signatures in the database for this song. When a match is not found, a new sample is typically obtained, and if a new search signature is produced, this new signature is used to search the database for a match. Having the ten most frequently occurring fingerprints for a song stored in the database increases the likelihood of a match being found quickly, but it also requires comparing the search signature to ten-times as many stored signatures; storing only one signature per song reduces the size of the database and the search-time for each search signature, but increases the likelihood of having to perform multiple searches using different acquired signatures.

Because of the likelihood of multiple signatures corresponding to the same song, the need for efficient search techniques exists even for relatively small databases, and is particularly crucial for large databases.

An object of this invention is to provide a method and system that facilitates the efficient search of a large database having large identifiers of the elements in the database. It is a further object of this invention to provide a method and system for organizing a large database having large identifiers of elements in the database for efficient searching of the database.

These objects, and others, are achieved by providing a method and system that effects a search of a large database based on a reordering of the conventional byte-order of multi-byte identifiers that identify elements in a database. The reordering is selected to provide a more uniform distribution of the identifiers in the database. The database is organized and/or sorted based on the reordered bytes forming the identifiers of the elements in the database. By effecting a reordered byte-order search of uniformly distributed identifiers, the likelihood of a mismatch being detected sooner can be expected to increase in most situations, thereby improving the speed of finding a match or exhaustively searching the database.

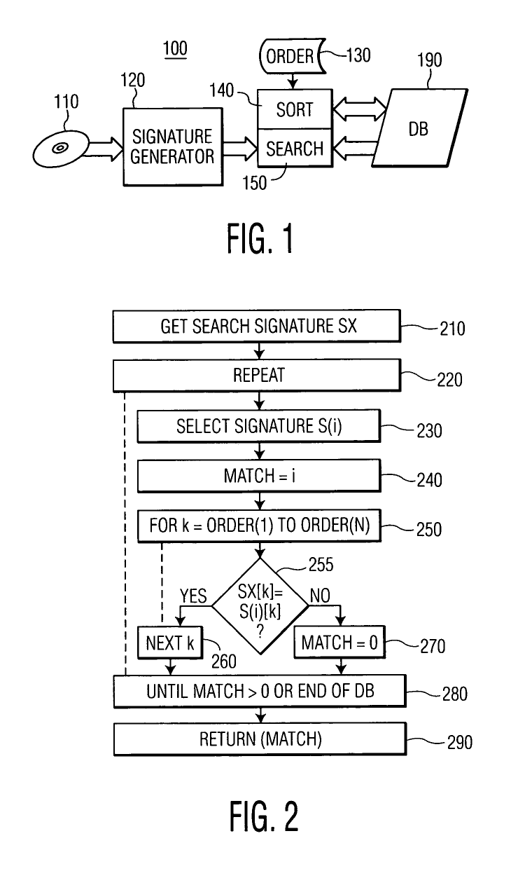

FIG. 1 illustrates an example block diagram of a signature-searching system in accordance with this invention.

FIG. 2 illustrates an example byte-reordered search of a database in accordance with this invention.

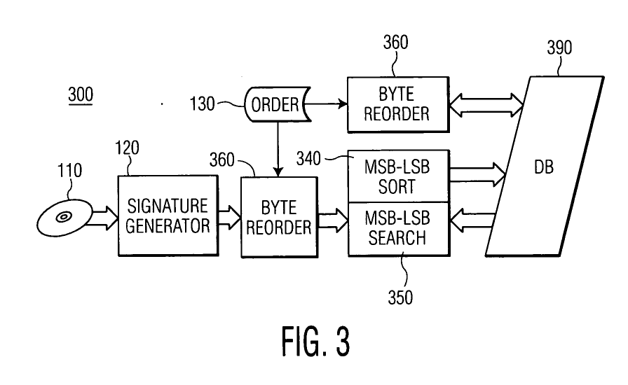

FIG. 3 illustrates an example block diagram of an alternative signature-searching system in accordance with this invention.

This invention is premised on the observation that the typical large-signatures derived from the contents of datasets do not exhibit a uniform distribution of data values among the bytes of the signatures. Generally, for example, the values of large-signatures exhibit “clustering”, wherein datasets of particular “types” exhibit similar signatures, and the values of the large-signatures are clustered about the signature values of each “type” of dataset. In a database of songs, for example, romantic ballads will generally have similar signatures that differ substantially from heavy-metal performances, and the heavy-metal performances will exhibit similar signatures that differ substantially from the similar signatures of waltzes, and so on. Further, in systems that provide multiple signatures for the same element in the database, the different signatures for the same element are often tightly clustered about a similar signature.

In a conventional search system using a relatively small-size identifier of elements in a database, the distribution of values of the identifiers has little to no effect on the efficiency of search. For example, a direct search of a database that employs a 16-bit (2-byte) identifier of elements is effected by a comparison of a 16-bit search word to each identifier until a match is found, or until the search word is compared with all of identifiers in the database. To improve the efficiency of the search, the database may be sorted, and the search is performed using the value of the search word to determine a range of identifiers to compare to the search word.

In a search system that is configured to search a database having large-size identifiers of elements in the database, however, the efficiency of search can be affected by the distribution of values of the identifiers. As detailed below, the efficiency of search of a database having large-size identifiers is particularly affected by a clustered-distribution of identifiers, and particularly if these clustered identifiers are stored in sorted-order in the database.

Consider the search of a database that uses a 128-byte signature to identify elements in the database, and assume that the elements in the database are sorted in the conventional manner, by ascending or descending values of the identifiers of the elements. Conventionally, the most-significant byte, or word, of the 128-byte search signature is compared to the corresponding most-significant byte of a select signature in the database. In a binary search, the select signature is typically the signature at the midpoint of the database.

For ease of reference, the term ‘byte’ is used hereinafter as a paradigm for ‘data-unit’. One of ordinary skill in the art will recognize that the terms ‘byte’, ‘word’, ‘double-word’, and so on are merely words of convenience, absent an identification of the number of bits forming the particular data-unit. A 32-bit ‘double-word’ in one context is equivalent to a 32-bit ‘word’ in another context, just as a 16-bit byte in one context is equivalent to a 16-bit word in another context.

If these bytes have matching values, the next-most-significant bytes of the search signature and the first signature in the database are compared, then the next-next-most-significant bytes, and so on. Note that the progression from most-significant-byte (MSB) to least-significant byte (LSB) is performed regardless of whether the signatures are stored in ascending or descending order, because the first mismatch in the MSB-to-LSB progression is used to determine the next selected signature in the database for comparison, as detailed below.

If the corresponding bytes do not match, the comparative magnitude of the byte values is used to determine the next selected signature in the database for comparison with the search signature. For example, using a binary search of an ascending-order database, if the mismatched search byte or word is larger than the corresponding byte or word in the selected signature, the next-selected signature in the database is the signature that is located half-way above the current select signature, where “half-way” is defined as half the prior range of possible select signatures in the database. In a descending-order database, the next-selected signature is the signature that is halfway below the current select signature.

Given a new selected signature, the above byte-by-byte comparison is performed until another mismatch is detected, or until all of the bytes of the search signature match all of the bytes of the selected signature. If a mismatch is detected, the above process continues until the range of possible select signatures is reduced to zero, at which point it is determined that there is no match in the database for the search signature.

For each selected signature in the database, a byte-by-byte comparison with the search signature will be performed until a mismatch is detected, or until all the bytes match. Thus, the average “dwell-time” at each selected signature is proportional to:
(Average number of bytes to detect a mismatch)*(1-P(match))+(Total number of bytes)*P(match)
where P(match) is the likelihood that the search signature matches the selected signature.

In a well-distributed population of signatures, the average number of bytes to detect a mismatch is independent of the value of the search signature. Consider, however, how this parameter is affected by a clustered-distribution. By definition, a “cluster” of similar valued signatures comprises signatures that have the same most-significant byte values. A ‘very tight’ cluster, for example, may contain signatures that only differ by the value of the least-significant-byte. A ‘wide’ cluster may contain signatures that only differ by the value of relatively few least-significant-bytes. Alternatively viewed, in a clustered-distribution of signatures, signatures that differ in their most-significant bytes will be in different clusters.

If the search signature is a randomly distributed value, the time to determine whether or not a match exists in a cluster-distributed database will be dependent upon whether the search signature lies within one of the clusters.

If the signature does not lie within a cluster, it will ‘quickly’ exhibit a mismatch with each selected signature in the database, because the most-significant bytes of this search signature is not likely to match the most-significant bytes of any of the clusters, and the average number of bytes to detect a mismatch will be relatively low.

If, on the other hand, the signature does lie within a cluster, the time to determine that a mismatch exists can be expected to increase, because when the search signature is compared to select signatures in the same cluster, the average number of bytes to detect a mismatch will be relatively high, corresponding to the number of matching most-significant-bytes that define the cluster. In the above example 128-byte signature of audio material, if romantic ballads exhibit the same upper-60 bytes of signature (leaving the remaining 68 bytes, or 25668 different values to distinguish among each romantic ballad), and the search signature is derived from a romantic ballad, the average number of bytes to detect a mismatch for each selected signature in this romantic-ballad cluster will be greater than 60 bytes. In like manner, if the multiple signatures corresponding to the same song differ only by the value of the lowest-order two bytes, the average number of bytes to detect a mismatch is over 126 bytes.

Thus, if the search signature is a random value, it will sometimes exhibit a relatively short search time, when its value does not lie within a cluster, and will sometimes exhibit a relatively long search time, when its value does lies within a cluster. Note, however, that in most instances, the search signature will be drawn from the same population that is used to create the database. That is, the search signature will generally lie within a cluster of the signatures in the database. In the example of audio entertainment, except in very rare cases will a signature of an unknown song be significantly different from every other song in a database of songs. Further, in a typical environment, a user may incrementally create a database of signatures, based on songs of interest to the user. Such a database is highly likely to contain clustered signatures, and queries to the database are likely to be based on songs exhibiting similar characteristics, until the user's taste in music changes, and a new cluster is formed.

In accordance with this invention, the comparison of large-size signatures is performed in an order that is substantially independent of clusters of signatures. In a preferred embodiment, the database of large-size signatures is organized in a byte-order that effects a more uniform distribution of values of the signatures. In an example structure, the database is sorted based on the least-significant-byte, then the next-least-significant-byte, and so on. Note that an ordering based on such a reverse-byte-order is not equivalent to an ordering based on a descending value. Given three signatures of 123, 654, and 271, wherein each digit corresponds to a byte value, a reverse-byte-order ascending sort order will be 271, 123, 654, because each of the least-significant digits are in ascending order.

Searches through this example database are effected based on a least-significant-byte to most-significant-byte comparison of a search signature to each select signature in the database. If the search signature, for example, is 723, and the select signature is 123, from the above example, the least-significant-digits, ‘3’ in both signatures, are compared first, then the next-least-significant-digits, ‘2’ in both signatures, are compared second, then the next-next-least-significant-digits, ‘7’ in the search signature, and ‘1’ in the selected signature, are compared last. Upon detecting a non-match between the ‘7’ and ‘1’, and noting that ‘7’ is larger than ‘1’, the next selected signature for comparison in the above example will be 654, beginning at the least-significant-digit of the search (‘3’) and select (‘4’) signatures.

Note that if the least-significant-bytes of the large-size signatures are uniformly distributed, the average number of bytes to detect a mismatch will be independent of the value of the search signature, and independent of any conventionally-defined clustering of the signatures in the database. Note also that if the search signature is drawn from the same population of signatures that are uniformly distributed with respect to a least-significant-byte to most-significant-byte ordering, the location of the search signature in a conventionally-defined cluster will have no effect on the average number of bytes required to detect a mismatch within this reverse-byte-ordered database.

Although an ordering from least-significant-byte to most-significant-byte is expected to be the easiest to implement, and most likely to produce a uniform distribution of signatures, one of ordinary skill in the art will recognize that any other ordering that provides a more uniform distribution than the conventional most-significant-byte to least-significant-byte ordering can be used. For example, it may be found that a particular signature creation scheme produces a non-uniform distribution of values of least-significant-bytes, and an ordering based on a high-to-low circular-ordering starting at a middle byte in the signature may be used to produce a more uniform distribution. In like manner, other unconventional ordering schemes may be employed, such as an ordering based on every third byte value, or based on alternating high-order then low-order bytes, and so on.

FIG. 1 illustrates an example block diagram of a search system 100 that is configured to effect a search for a signature based on an order 130 that differs from the conventional MSB-to-LSB order of the signature produced by a signal generator 120 to identify content material 110. The order 130 is used to sort 140 signatures in a database 190. Using the example set of signatures 123, 654, and 271, and the symbol a-b-c for the conventional MSB-to-LSB ordering, where a is the MSB, an order 130 of c-b-a will provide a sort of the signatures of 271, 123, 654; an order 130 of b-c-a will provide a sort of 123, 654, 271; and so on.

The order 130 is also used to effect the search for a match to a search signature that is produced by a signature generator 130, the search signature being based on contents of a dataset 110.

FIG. 2 illustrates an example flow diagram for effecting a search for a signature based on a specific order of bytes forming the signature. At 210, the search signature is received, and the loop 220-280 is repeated until a match is found or until the search is exhausted. At 230, a select signature is identified, using conventional techniques. For example, using a binary search, the signature in the middle of the current search range is the select signature. At the start of the loop 220-280, the search range is the entire database, and each execution of the loop cuts the range in half. Other techniques for selecting samples in an ordered search are common in the art. In like manner, ordered-search techniques other than, or variants of, a binary-search are common in the art, such as a B-tree search and others; see, for example, The Art of Computer Programming, Vol. 3: Sorting and Searching, D. Knuth, Addison-Wesley Publishing Co. (1973).

At 240, a match parameter is set to identify the currently selected signature from the database, and the loop 250-260 is executed to determine whether all of the bytes of the search signature match all of the bytes of the selected signature. If the loop 250-260 is exhausted without a mismatch, the loop exits with the match parameter being equal to the identifier of the selected signature. The loop 250-260 compares the bytes of the search signature and the select signature, in the specified order. At 255, the currently identified byte of the search signature, in the specified order, is compared to the corresponding byte in the select signature. For example, using the above a-b-c representation of ordering, if the specified order is b-a-c, the second digit (‘b’) of the signatures are compared first, then the first digit (‘a’) is compared, then the last digit (‘c’) is compared. If the corresponding bytes do not match, at 255, the match parameter is set to a value that does not correspond to an identifier of a signature in the database, such as zero, at 270, and the loop 250-260 is terminated. If, at 280, the match parameter is zero, the loop 220-280 is repeated, except if the search of the database is exhausted.

At 290, the match parameter is returned, as either an identifier of the select signature in the database that matches the search signature, or as a value that does not identify a signature in the database, such as the example zero, above. Not illustrated, if the match parameter indicates that a match was not found for the search signature, the user is given the option of adding the search signature to the database. In a preferred embodiment, a first-in first-out (FIFO) strategy is used to provide room in the database, if necessary, for adding the search signature and ancillary information.

As noted above, if the specified order results in a more uniform distribution of signatures in the database than the conventional MSB-to-LSB order, the average number of bytes that are compared in the loop 250-260 before a mismatch at 255 is found can be expected to be lower than a conventional MSB-to-LSB search, particularly if the signatures exhibit a conventional clustered distribution.

Note also that the above algorithm can be effected by storing the multi-byte signatures in a conventional database using the aforementioned unconventional byte ordering. FIG. 3 illustrates an example block diagram of an alternative search system 300 wherein the bytes of each signature are reordered based on the specified order 130. For example, if the specified order is c-b-a, the example signatures 123, 654, 271 are reformed into reordered signatures 321, 456, 172 by reversing the order of each signature's digits. By reordering 360 the bytes of the signatures in the database 390, a conventional MSB-to-LSB sort 340 and search 350 can be used to effect an efficient search, provided that the bytes of the search signature is also reordered using the same by reordering process 360.

The conventional MSB-to-LSB sorter 340 in this example 300 places the reordered-byte signatures in ascending (or descending) order, relative to the reordered-byte order. In the example above of a c-b-a ordering, the original 123, 654, 271 signatures are stored in the database as 172, 321, 456. The search signature (723 in the above example) is also byte-reordered as c-b-a, to form a byte-reordered search signature of 327. A conventional binary search of the byte-reordered search signature to the stored byte-reordered signatures will effect a conventional MSB-to-LSB comparison of 327 with 321, then a MSB-to-LSB comparison of 327 with 456, corresponding to the above described technique of performing a LSB-to-MSB ordering and search.

The foregoing merely illustrates the principles of the invention. It will thus be appreciated that those skilled in the art will be able to devise various arrangements which, although not explicitly described or shown herein, embody the principles of the invention and are thus within its spirit and scope. For example, because the creation of a signature from content material is not precise, as discussed above, the search scenario can be structured to declare a “match” even when a few bits of the signature do not match. One of ordinary skill in the art will recognize that the decision block 255 of FIG. 2 can be modified to correspond to a relaxed match criteria. This relaxed criteria can be, for example, based on the number of bits of the byte that do not match, or the cumulative number of bits in the signature that do not match, or, to the cumulative number of bytes in the signature that do not match. Such a relaxed criteria will likely lead to a match determination more quickly than an exhaustive search that finds a match based on the fewest number of bit differences. However, a determination of a non-match using a relaxed criteria in a sorted search is not necessarily conclusive, and a subsequent exhaustive search may be used to verify a true non-match. These and other system configuration and optimization features will be evident to one of ordinary skill in the art in view of this disclosure, and are included within the scope of the following claims.

1. A method of searching a database that uses multi-data-unit signatures to identify elements in the database, comprising:
creating a search signature that includes a plurality of data-units, the plurality of data-units having a first order, from most-significant data-unit to least-significant data-unit,
determining a select signature of the multi-data-unit signatures,
sequentially comparing each data-unit of the plurality of data-units of the search signature to a corresponding data-unit of the select signature, using a second order of sequential data-units, until a difference is detected, or until all data-units of the plurality of data-units have been compared; wherein
the second order differs from the first order.

2. The method of claim 1, wherein
the database is sorted based on the second order.

3. The method of claim 1, further including
sorting the database based on the second order.

4. The method of claim 1, wherein
the second order corresponds to an inverse of the first order.

5. The method of claim 1, wherein
the search signature is based on contents of at least one of:
an audio dataset, and
a video dataset.

6. The method of claim 1, wherein
the database is configured to also include ancillary information related to the elements identified by the multi-data-unit signatures, and
the ancillary information includes at least one of:
a title of the element,
an author of the element,
a performer of the element,
a director of the element, and
a producer of the element.

7. A method of searching a database that uses multi-data-unit signatures to identify elements in the database, comprising:
creating a search signature that includes a plurality of data-units, the plurality of data-units having a first order, from most-significant data-unit to least-significant data-unit,
reordering the search signature based on a second order that differs from the first order,
determining a select signature of the multi-data-unit signatures,
sequentially comparing each data-unit of the plurality of data-units of the search signature to a corresponding data-unit of the select signature, using the first order of sequential data-units, until a difference is detected, or until all data-units of the plurality of data-units have been compared.

8. The method of claim 7, wherein
data-units of the multi-data-unit signatures are reordered based on the second order, and
the database is sorted based on the first order.

9. The method of claim 7, further including
reordering data-units of the multi-data-unit signatures based on the second order, and
sorting the database based on the first order.

10. The method of claim 7, wherein
the second order corresponds to an inverse of the first order.

11. The method of claim 7, wherein
the search signature is based on contents of at least one of:
an audio dataset, and
a video dataset.

12. The method of claim 7, wherein
the database is configured to also include ancillary information related to the elements identified by the multi-data-unit signatures, and
the ancillary information includes at least one of:
a title of the element,
an author of the element,
a performer of the element,
a director of the element, and
a producer of the element.

13. The method of claim 7, further including
storing the search signature in the database using a first-in first-out storage strategy.

14. A search system comprising:
a signature generator that is configured to produce a search signature having a first order of data units corresponding to a most-significant data-unit to least-significant data-unit order, and
a search engine that is configured to search a database for a select signature corresponding to the search signature, wherein
the search engine is configured to sequentially compare each data-unit of the search signature to a corresponding data-unit of the select signature based on a second order of data units that differs from the first order.

15. The search system of claim 14, wherein
the database is sorted based on the second order.

16. The search system of claim 14, further including
a sorter that is configured to sort the database based on the second order.

17. The search system of claim 14, wherein
the second order corresponds to an inverse of the first order.

18. The search system of claim 14, wherein
the search signature is based on contents of at least one of:
an audio dataset, and
a video dataset.

19. The search system of claim 14, wherein
the database is configured to also include ancillary information related to an element identified by the select signature, and
the ancillary information includes at least one of:
a title of the element,
an author of the element,
a performer of the element,
a director of the element, and
a producer of the element.

20. A search system comprising:
a signature generator that is configured to produce a search signature having a first order of data units corresponding to a most-significant data-unit to least-significant data-unit order,
a data-unit reorderer that is configured to reorder data-units of the search signature based on a second order of data units that differs from the first order, and
a search engine that is configured to search a database for a select signature corresponding to the search signature, wherein
the search engine is configured to sequentially compare each data-unit of the search signature to a corresponding data-unit of the select signature based on the first order.

21. The system of claim 20, wherein
data-units of the select signature are reordered based on the second order, and
the database is sorted based on the first order.

22. The system of claim 20, wherein
the data-unit reorderer is further configured to reorder data-units of signatures in the database based on the second order, and
the system further includes
a sorter that is configured to sort the database based on the first order.

23. The system of claim 20, wherein
the second order corresponds to an inverse of the first order.

24. The system of claim 20, wherein
the search signature is based on contents of at least one of:
an audio dataset, and
a video dataset.

25. The system of claim 20 wherein
the database is configured to also include ancillary information related to an element identified by the select signature, and
the ancillary information includes at least one of:
a title of the element,
an author of the element,
a performer of the element,
a director of the element, and
a producer of the element.
